(19) United States
(12) Patent Application Publication
(10) Pub. No.: US 2026/0024463 A1
(43) Pub. Date: Jan. 22, 2026

(54) Sail Training With Real-Time Video Analysis

(71) Applicant: WhitServe LLC, Stamford, CT (US)

(72) Inventors: Wesley W. Whitmyer, JR., Stamford, CT (US); Declan W. Whitmyer, Stamford, CT (US)

(21) Appl. No.: 19/063,800

(22) Filed: Feb. 26, 2025

Related U.S. Application Data
(60) Provisional application No. 63/673,871, filed on Jul. 22, 2024.

(51) Int. Cl. G09B 19/16; G09B 5/06

(52) U.S. Cl. CPC G09B 19/162; G09B 5/065

(57) ABSTRACT

A system for sailing training includes at least one tuning parameter of a sailboat which can be set to multiple positions; a camera mounted on the sailboat for recording a video of a current position of the at least one tuning parameter; a mobile computing device for controlling the camera; an app executing on the mobile computing device for analyzing the position video of the at least one tuning parameter of the sailboat and for determining in real-time using AI how to modify the current position of the tuning parameter to maximize performance of the sailboat; and a notification generated by the mobile computing device for alerting a sailor to the preferred tuning parameter position.

### TECHNICAL FIELD

The present application relates to sailing. In particular, the present application relates to systems for improving sailboat performance training.

### BACKGROUND

Sailboat racing is a sport in which the court is constantly changing and never the same. The virtual lines of a sailboat racecourse are constantly moving with every small change of wind or waves. This makes learning to be a competitive sailor quite difficult. Every decision you make needs constant adjustment due to ever-changing conditions.

Even if the racecourse wasn't continuously changing in a material way, maximizing speed of a racing sailboat requires an experience-based accumulation of 1000s of small tuning details in order to improve performance. Then in an instant, more and different adjustments to sailboat settings and controls are needed to account for the ever-changing racecourse conditions.

Further complexity exists due to the plethora of control and setting options that exist on many sailboats. Examples include standing rigging (forestay, sidestays, spreaders, backstays and others), running rigging (sheets, traveler, Cunningham, vang outhaul, halyard, and others), car position, sheeting angle, sheeting tension, sail depth, sail shape, sail twist, boom height, boom centerline, traveler position, tiller position, in-haul and cross sheeting options, and many others. Each of these controls often has an adjacent number scale on which sailors can read a memory mark in order to equalize settings on port and starboard. That's right, each of these controls must be set on both tacks for all points of sail, and must be reset a dozen or more times per race.

Due to the complexity, many sailing maxims have arisen to provide helpful shortcuts to sailboat tuning for novice sailors. These maxims, such as “tiller toward trouble” and “ease until the sail backwinds,” are fine for a beginning sailor but are geared toward safety rather than performance, such that they need to be unlearned in order to learn the finer points of sail trim and sailboat performance.

As technology has advanced, attempts have been made to use video for sailboat training. Cameras are set up around the boat, or in a drone or coach boat, and after sailing the footage is downloaded to a computer for review—with or without other items of time-synced performance data. Video is used to analyze past events. No learning happens immediately when mistakes are made, or memory marks are forgotten.

Post-race performance data can include things such as speed over ground, course over ground, heading, heel, trim, distance to the line, position and others. The performance data is directly sensed by instruments mounted to sailboats, and time-syncing it to video can be a valuable tool to learn the finest points of sail trim and sailboat racing. Obviously, the quality and quantity of the performance data available will impact the quality of the sailboat trim and control learning that can be achieved by such a system.

As well, the current systems suffer that shortcoming that they cannot be used to improve current performance. They cannot be used to foster real-time learning.

What is needed therefore is a system to enhance sail training with real-time video analysis.

### SUMMARY

The invention provides a solution to these and other shortcomings of sailboat performance training systems.

In one aspect, the invention provides a sail training system that uses a camera to visually capture and analyze one or more settings on a sailboat in real time.

In another aspect, the invention provides a sail training system that uses a mobile computing device having a camera to visually capture and analyze one or more settings on a sailboat in real time.

In still another aspect, the invention provides a sail training system that uses a smartphone to visually capture and analyze one or more settings on a sailboat in real time.

In yet another aspect, the invention is a system that uses real-time video to provide actionable notification to sailors for improved performance.

In a further aspect, the invention provides a sail training system that uses a drone to visually capture and analyze one or more settings on a sailboat in real time.

In yet a further aspect, the invention is a sail training system that uses AI to analyze video of at least one setting on a sailboat to provide actionable notification to sailors for improved performance.

### BRIEF DESCRIPTION OF THE DRAWINGS

FIG. 1 shows a system according to the present teachings.

FIGS. 2a and 2b show depictions of one embodiment of a system according to the present teachings, wherein a tiller is the tuning parameter 101 and wherein the camera 102 is present on a smartphone which comprises the mobile computing device 103.

### DETAILED DESCRIPTION

The present teachings are described more fully hereinafter with reference to the accompanying drawings. The following description is presented for illustrative purposes only and the present teachings should not be limited to these embodiments.

In compliance with the statute, the present teachings have been described in language more or less specific as to structural features. It is to be understood, however, that the present teachings are not limited to the specific features shown and described, since the systems herein disclosed comprise preferred forms of putting the present teachings into effect.

Generally, all terms used in the claims are to be interpreted according to their ordinary meaning in the technical field, unless explicitly defined otherwise herein. All references to a/an/the element, apparatus, component, means, step, etc., are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc., for different features/components of the present disclosure are only intended to distinguish the features/components from other similar features/components and not to impart any order or hierarchy to the features/components.

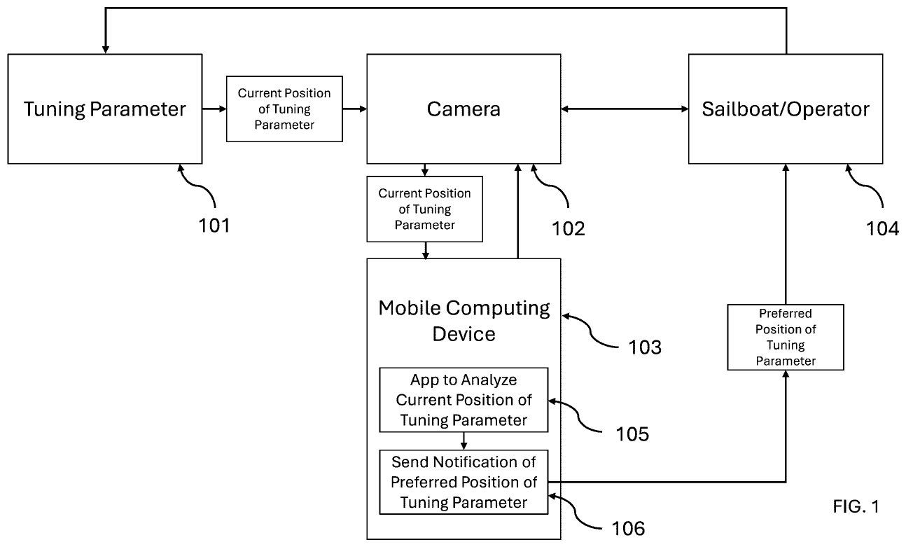

FIG. 1 presents one view of a system according to the present teachings. FIG. 1 includes a tuning parameter 101, a camera 102, a mobile computing device 103, a sailboat 104, an application 105 (referred to variously herein as “app” or “application”), and a notification 106.

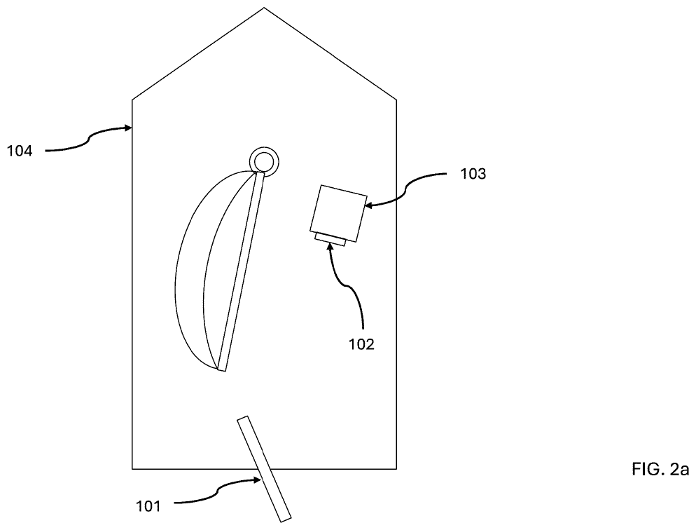

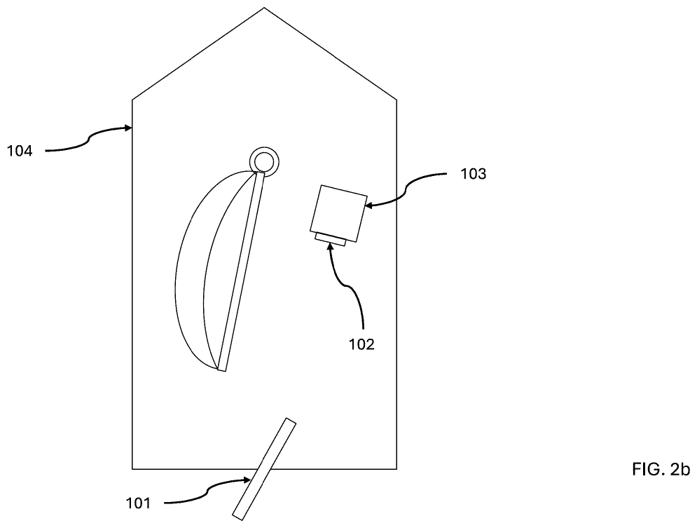

FIGS. 2a and 2b present two views of a system according to the present teachings. FIGS. 2a and 2b include a tuning parameter 101, a camera 102, and a mobile computing device 103, and a sailboat 104.

The tuning parameter 101 shown in FIGS. 2a and 2b is the position of a tiller. However, any adjustable feature of a sailboat can constitute a tuning parameter 101, including without limitation, the sail shape, the sail tension, the jib, and the boat trim.

As seen in FIGS. 2a and 2b, the tuning parameter 101 (shown as a tiller) is capable of changing position. This change in position of the tuning parameter 101 is captured by the camera 102, whose field of view is preferably sufficiently wide such that the maximum amount of the tuning in any direction can be recorded. However, it may be the case in some embodiments of the present teachings that the camera 102 cannot capture the maximum amount of tuning in any direction for a tuning parameter 101.

The camera 102 is present on the sailboat 104. The camera 102 may be rigidly mounted to the sailboat 104 or a component of the sailboat 104 or may be present in another means (e.g., handheld) on the sailboat 104. It is preferred that the camera 102 be in a relatively stable position when recording the tuning parameter 101 to ensure maximum accuracy.

The camera 102 may be in one of many forms, including, without limitation, mounted to a smartphone or other mobile device, a standalone camera (e.g., a DSLR, action camera), or a drone. The camera 102 may also be mounted on the mobile computing device 103. In some embodiments, the camera 102 may be a separate component from the mobile computing device 103. In embodiments where the camera 102 is a separate component from the mobile computing device 103, the camera 102 and the mobile computing device 103 are preferably capable of electronic communication with each other.

In the embodiment shown in FIGS. 2a and 2b, the camera 102 is mounted on the mobile computing device 103. The mobile computing device 103 may be a smartphone or other portable device. The mobile computing device 103 is preferably capable of controlling the camera 102, including, without limitation, where applicable, controlling the zoom function of the camera 102. The mobile computing device 103 is envisioned in other forms in addition to a smartphone, including a tablet computer.

Use of a system according to the present teachings may be expressed through an example. When a sailor wishes to track their progress, they may mount a camera 102 on their sailboat 104 and ensure that the camera 102 is facing the direction of the tuning parameter 101 they wish to receive feedback about. For example, if the sailor wishes to receive feedback about the tiller, he will point the camera 102 towards the tiller. The sailor may mount the camera 102 to the sailboat 104 such that the camera 102 remains rigid while the sailboat 104 is in motion. The sailor then operates the mobile computing device 103 to begin recording the tuning parameter 101. Once the camera 102 begins capturing footage, or prior to the camera 102 capturing footage, an application 105 executes on the mobile computing device 103. The application 105 preferably analyzes the footage captured by the camera 102 with minimal latency and provides feedback to the sailor with respect to how the sailor should tune the tuning parameter 101. In some cases, the application 105 may use artificial intelligence to analyze the footage captured by the camera 102. The feedback provided to the sailor as a result of the analysis performed by the application 105 may come in the form of a notification 106 on the mobile computing device 103. If a notification 106 is generated on the mobile computing device 103 to alert the sailor of feedback, the notification 106 is envisioned in many forms, including without limitation, through sounds (e.g., dialogue instructing the sailor to take some action) or visual feedback (e.g., messages instructing the sailor to take some action).

Throughout the sailor's journey, it is envisioned that the mobile computing device 103 may continuously provide feedback to the sailor with respect to a preferred position of the tuning parameter 101.

It is envisioned that, in some cases, the sailor may need to operate an application 105 on the mobile computing device 103 prior to recording the tuning parameter 101 with the camera 102. The application 105 operating on the mobile computing device 103 may have a feature which allows the sailor to select from one or more preset options (e.g., where the tuning parameter 101 is a tiller). In some embodiments, the application 105 may analyze the position of the tuning parameter 101 to provide feedback. In some embodiments, the application 105 may analyze the change in position of the tuning parameter 101 to provide feedback.

The artificial intelligence implemented in the application 105 may be trained on time-synchronized video and sensor data as well as known handling characteristics (e.g., hull shape, mast height, etc.) from a plurality of boats.

What is claimed is:

1. A sail training system comprising:
at least one tuning parameter of a sailboat which can be set to multiple positions;
a camera mounted on the sailboat for recording a video of a current position of the at least one tuning parameter;
a mobile computing device for controlling said camera;
an app executing on said mobile computing device for analyzing the position video of the at least one tuning parameter of the sailboat and for determining in real-time using AI how to modify the current position of the tuning parameter to a preferred position to enhance performance of the sailboat; and
a notification generated by said mobile computing device for alerting a sailor to the preferred tuning parameter position.

2. The sail training system of claim 1, wherein the tuning parameter is the position of a tiller.

3. The sail training system of claim 1, wherein the mobile computing device is a smartphone.

4. The sail training system of claim 1, wherein the mobile computing device is a tablet computer.

5. The sail training system of claim 1, wherein the app executing on said mobile computing device is configured to provide a selection of tuning parameters.

6. The sail training system of claim 1, wherein the AI has been trained based on a plurality of time-synchronized videos and sensor values from a plurality of boats having known handling characteristics.

7. A sail training system comprising:
at least one tuning parameter of a sailboat which can be set to multiple positions;
a camera mounted on the sailboat for recording a video of a current position of the at least one tuning parameter;
a mobile computing device for controlling said camera;
an app executing on said mobile computing device for analyzing the position video of the at least one tuning parameter of the sailboat and for determining in real-time if the parameter position has changed; and
a notification generated by said mobile computing device for alerting a sailor to the changed parameter position.

8. The sail training system of claim 7, wherein the app implements AI for analyzing the position video and determining if the parameter position has changed.
